(19) United States
(12) Patent Application Publication
(10) Pub. No.: US 2009/0102654 A1
(43) Pub. Date: Apr. 23, 2009

(54) SYSTEMS AND METHODS FOR OPERATING A SURVEILLANCE SYSTEM

(75) Inventors: Roland Schoettle, American Canyon, CA (US); Peter El Kwan Chow, Orlando, FL (US)

Correspondence Address: FULBRIGHT & JAWORSKI L.L.P, 2200 ROSS AVENUE, SUITE 2800, DALLAS, TX, 75201-2784, US

(73) Assignee: Optimal Innovations Inc., Bridgetown (BB)

(21) Appl. No.: 11/876,536

(22) Filed: Oct. 22, 2007

(51) Int. Cl. G08B 13/18

(52) U.S. Cl. 340/552

(57) ABSTRACT

A surveillance system can be designed to take advantage of the disruption of the electromagnetic propagation (EMP) of the radio waves as they propagate through a spatial volume from a transmitter to a receiver. This disruption is well-known in the RF field and is usually removed from becoming a problem in any bidirectional transmission by a variety of sophisticated techniques. Advantage is taken of the fact that the presence and/or movement of objects within the range of the transmission has some effect on the resultant reception. Thus, the disruption of the EMP between two points can be used to provide surveillance information over a wide area. In one embodiment, radios are used that can detect and adapt to changes in the EMP medium and thus are able to adapt to changing circumstances in real-time.

### TECHNICAL FIELD

This disclosure relates to surveillance systems and more specifically to methods and systems for performing surveillance using radio communication systems.

### BACKGROUND OF THE INVENTION

Surveillance systems are now commonplace and deployed in a wide variety of circumstances. Such systems can be as simple as a camera and a monitor and complex utilizing a combination of pressure sensors, RE and light beams, sound detectors and the like. Some of the most sophisticated surveillance systems use an invisible (to the human eye) laser beam between a source and destination point(s) where detection is based on an object passing through the beam thereby interrupting the light path from the sending point and the destination point.

One disadvantage of such systems is that when the protected environment changes (such as for example, an object is positioned within the protected zone) the transmission and reception points must be adjusted to accommodate the intrusion. By way of example, a problem would occur when a floor of a building is under surveillance using laser beams and it is desired to have a guard walk the area from time to time. Care must be taken to eliminate or redirect the laser beams before the guard passes.

The foregoing has outlined rather broadly the features and technical advantages of the present invention in order that the detailed description of the invention that follows may be belter understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF SUMMARY OF THE INVENTION

A surveillance system can be designed to take advantage of the disruption of the electromagnetic propagation (EMP) of the radio waves as they propagate through a spatial volume from a transmitter to a receiver. This disruption is well-known in the RF field and is usually removed from becoming a problem in any bidirectional transmission by a variety of sophisticated techniques. Advantage is taken of the fact that the presence and/or movement of objects within the range of the transmission has some effect on the resultant reception. Thus, the disruption of the EMP between two points can be used to provide surveillance information over a wide area. In one embodiment, radios are used that can detect and adapt to changes in the EMP medium and thus are able to adapt to changing circumstances in real-time.

### BRIEF DESCRIPTION OF THE DRAWINGS

For a more complete understanding of the present invention, reference is now made to the following descriptions taken in conjunction with the accompanying drawing, in which.

FIG. 1 illustrates an embodiment of a radio surveillance system using the concepts of the invention;

FIG. 2 illustrates one embodiment of a changed signature occasioned by the addition of an object into the transmission space;

FIG. 3 illustrates one embodiment of the radio function used in the present invention;

FIG. 4 illustrates one embodiment of an alert processing system;

FIG. 5 illustrates one embodiment of a GUI for radio grouping;

FIG. 6 shows one embodiment for defining the alert action;

FIG. 7 illustrates one embodiment of an operator interface for an alert setting; and

FIG. 8 shows one embodiment of a flow chart of system operation.

### GENERAL DESCRIPTION OF THE INVENTION

Radio surveillance can be performed using either a dedicated system or in combination with a radio communication system serving another purpose. For example, in many environments there are several wireless transmissions already occurring for various purposes. Any one or more of these can be used to also provide surveillance of the area surrounding the wireless communication. This is accomplished because the radios (transmit and receive) of the existing system detect changes in the environmental conditions within the area, for example refraction or reflection off of an object causes the EMP to change. These changes need not be in the direct line between the transmitter and the receiver since the receiver is subjected to “bounce” and multi-path reception.

The radio surveillance concepts presented herein have the fundamental characteristics of laser beam systems but with more capabilities and enhanced features. In one embodiment, two radios are used with both radios being transceivers, in that they can both transmit as well as receive. The example then is a bidirectional detection system where each EMP transmission in any direction can be different (e.g., the EMP characteristics for each of the transmitters and receivers are not necessarily the same). Each radio has a set of spatial signatures of EMP characteristics for transmitting and receiving. Any object, within the electromagnetic field impacts the spatial signature and signal performance and therefore can be detected by the receiving radio(s).

For example, when a new object moves into the EMP field, each radio detects a change from the previously received signal and from the initial channel calibration process and thus a new spatial signature is created. This change in signature triggers the alert process. It should be clear that the surveillance area covered by these two radios is much larger than the point to point laser beam approach, because the radio wave reflects and refracts to cover and differentiate signals over a wide area whereas the laser is essentially a beam. Take, for example, a typical garage door that stops its closing motion when the light beam is broken by an object (typically a person) moving across the beam. If the person were to step over the beam the garage door would not stop. If, on the other hand, the concepts discussed herein were to be used, the radio detection system would sense the change in the EMP and stop the door. Note that the using this approach, alignment problems are eliminated and, if desired, a wider area of coverage could be monitored by the radio beams.

Other advantages provided by this invention are 1) that the invisible electromagnetic field coverage area or pattern could be changed instantly by moving or adding a reflecting object thereby providing multiple “baselines” for alerting purposes. For example, the same deployment of the invention can be used for various partitioning schemes as can be found in many conference halls with changeable walls; 2) larger areas can be covered than by other known methods; 3) stationary non-reflecting or refracting objects (of which there are few can be easily converted to extend the surveillance area by the addition of small reflective coatings or coverings; 4) higher powered radios can be used (either continuously higher powered or in a “burst” mode) to cover larger areas or to provide greater alerting detail; 5) additional radios can be added or subtracted to the system, especially those already part of an otherwise standard communication system, with little or no effort; and 6) additional radios can be added automatically so as to provide the ability to auto-discover and auto-add new “zones” to the overall alerting system and the total region it includes.

Before beginning a discussion of the operation of one embodiment of the invention, it might be helpful to review some of the basics of RF transmission. Any wireless system communication is based on the propagation of an electromagnetic field (EMF) wave. The antenna is the interface device or component that converts the electrical signal to EMF and vice versa. Once converted, the EMF wave propagates freely in the air. The wave is typically reflected or refracted when it reaches an obstacle or object and the change from original wave to the reflected or refracted can therefore be used to identify the range (e.g., from the echo delay, instantaneous direction from the antenna (pointing direction), and/or speed of both moving and fixed objects from the doppler frequency shift). This is the operating principle of Radar.

Within a building, there are many objects, including walls, furniture, people, pets, etc. Each reflection can be considered as a delayed version (or image) of the source signal. Technically, this environment is referred to as a multi-path environment. Multipath is the EMF wave propagation phenomenon that results in radio signals' reaching the receiving antenna by two or more paths. The typical characteristic of a multi-path environment is “notching” in frequency response of the medium signal due to cancellation between two signals that have the same frequency, but different phases or time delay. (“Notching” has the typical appearance as zeroes.) If there are zeroes, then there likely are peaks which are difficult to detect. Therefore, the difference in time delay can be computed from two received signals. In general, multi-path environments suffer from significantly reduced radio performance and have been a decades-old challenge. Today, there are three solutions used to overcome this problem. Solutions to these are discussed below.

Orthogonal Frequency-Division Multiplexing (OFDM) is a digital multi-carrier modulation scheme, which uses a large number of closely-spaced (small narrow-band) orthogonal sub-carriers. OFDM effectively creates many sub-channels from one large bandwidth channel with the advantage of being far better able to cope with severe channel conditions without complex equalization filters. The signal is transmitted in each sub-channel independently, effectively parallelizing the transmission media so that communication is not stopped even if some sub-channels encounter severe interference. The OFDM modulation scheme works well in the multi-path environment, where signal loss on some sub-channels from signal cancellation at some frequencies still allows data to flow on all other sub-channels. In other words, the multi-path environment may cause some of the sub-channels to be unusable, but will still allow data to flow on the remaining sub-channels—the communication link is always active, but not necessarily operating at full capacity.

OFDM requires that each receiving radio knows which sub-channels work. Sub-channel discovery can be performed by a protocol between the sending and receiving radios. For example, either radio can initiate the necessary sub-channel realignment process to maximize throughput at any time by sending a unique key code through all sub-channels. The receiving radio determines which sub-channels have the received data so as to create the next key code based on the best sub-channel throughput pattern. The key is then used until next discovery is performed as per the protocol. The details of the protocol are not discussed here, because they are irrelevant to this invention. What is important for this invention is the ability to determine and adapt to a changing environment using the best sub-channel throughput patterns.

Direct-Sequence Code Division Multiple Access (DS-CDMA) is a multiple access scheme based on direct-sequence spread spectrum, by spreading the signals from/to different transmitters with different codes. This spread spectrum approach trades bandwidth for signal quality in noisy environments—thereby increasing transmission rates by N times. For example, in the IS-95 Cellular standard, N is 128. The relevant characteristic is managing the multi-path environment with a “Rack” filter. The function of the “Rack” filter is to present multi-delayed signal contents of the received signal in the order of time delay. For example, assuming there are three signal paths from a transmitter to a receiver, where one of the three paths is the direct path and the other two are reflected or refracted by walls and/or furniture. In this case the signal from the direct path will arrive first, because it is the shortest distance. The other two signals will arrive later. The “Rack” filter output will display three signals in the order of their propagation time delay from the transmitter. Should the environment change, the delay time and signal strength of each signal will also change. The invention presented herein is based on the principle of detecting changes in the local environment.

Multiple-input and multiple-output, or MIMO uses multiple antennas and signal processing both at the transmitter and receiver to improve the performance of radio communication systems. MIMO offers advanced control over the spatial distribution of the electromagnetic field energy which in turn offers significant increases in data throughput and link range without additional bandwidth or transmit power. It achieves this by higher spectral efficiency (more bits per second per Hertz of bandwidth) and link reliability or diversity (reduced fading). In other words, MIMO adaptively controls the strength and the direction of the electromagnetic field. In a multi-path environment, MIMO radios (transceivers) can adapt and optimize their performance to the local environment. Radio link adaptation operation involves one radio, R1, at one end of the radio link which transmits a beacon signal. The receiver, R2, at the other end of the link processes all received signals from all antennas to achieve the best single output signal. This is accomplished by changing the magnitude, A, and phase, φ, of each antenna signal. (The details of the optimization algorithm for MIMO are not discussed here, because they are irrelevant to this invention. What is important for this invention is the ability to determine and adapt to a changing environment using MIMO signal matching (e.g., signature patterns)). The spatial signatures per radio link per direction [1], [2] is characterized by a set of As and φs. The next step is for Radio R2 to respond with a beacon signal using the spatial signature settings. If R1 determines the channel signature is significantly different to the one used previously, the adaptation process continues until the new channel signature is similar to the previous one. The whole process takes a few micro-seconds. Communication starts once the channel signature is known.

In summary, OFDM, DS-CDMA and MIMO technologies, as described above, have the capability of adapting to changes in the environment. These technologies can therefore be used together to create a new radio-based detection system (e.g., either OFDM or CDMA can be coupled with MIMO). Of particular interest is the ability to incorporate advanced modulation as well as multiple antennas and signal processing as may already exist in commercial products for this purpose. For an example, WiFi chips AGN400 [3] from Airgo Networks is based on OFDM and MIMO, while WFB400 [4] from Qualcomm is based on DS-CDMA and MIMO.

### DETAILED DESCRIPTION

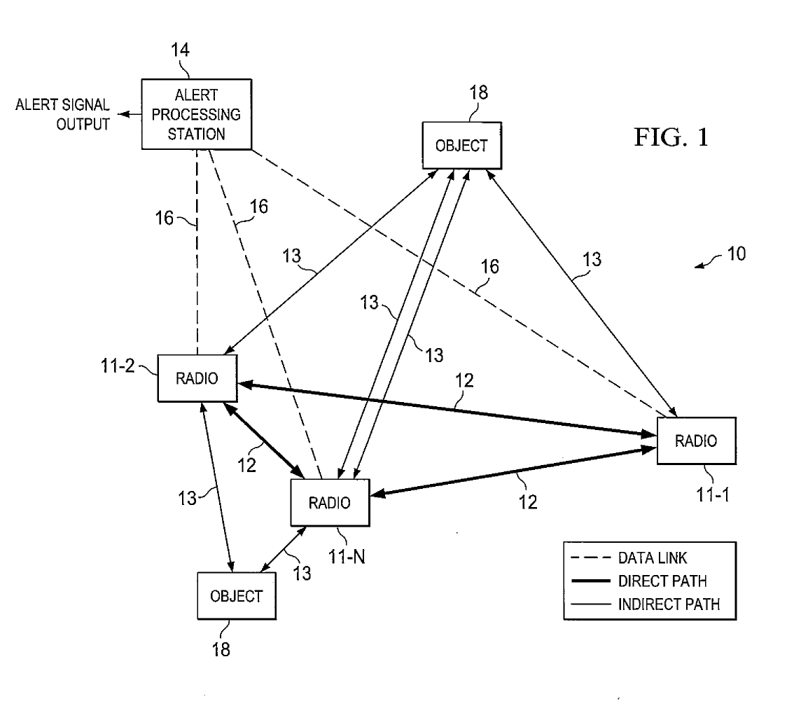

FIG. 1 shows one embodiment 10 of a radio based surveillance system. System 10 has at least two radios, such as radios 11-1 to 11-N, and an alert processing station, such as station 14 communicating with the various radios via data links 16. Note that the alert processing station can be separate as shown or integrated with one or more radio nodes. System 10 operation starts from a set of radios that are installed in an area where surveillance is required. The number of radios required is based on the size of a three dimensional coverage area (volume), including areas that actively reflect and/or refract the radio signals and the level of surveillance detail that is required. Assuming output power per radio is not increased, large areas and high surveillance detail requirements will drive up the number of radios. Note that, as discussed above, these radios can be part of a communication system, such as a phone system, a wireless data network, etc., that is in place independent of the surveillance system. It should be noted that the spatial signature includes spectral information.

When being used for surveillance purposes, the communication is always between two radios comprising at least one communication link. Whether one or multiple communication links are used at-a-time is immaterial to the operation of the surveillance system as long as each radio transmits on a regular basis (e.g., every second). The communication link is based on the electromagnet propagation (EMP) environment which could consist of direct paths, such as path 12 or/and indirect paths 13 caused by objects, such as objects 14. The receiver in this EMP environment (also referred as multi-path environment) experiences multiple identical input signal patterns separated by time delays and signal strength magnitudes which can be characterized as a spatial signature. The EMP environment would be static if all reflective objects were static. The radio used in this embodiment has self adaptive capability to the EMP environment changes, so the performance is acceptable for unrestricted deployment of the radio system. This is because the EMP environment could be different in any new deployment and adapts to the on-going spatial changes in the environment from time to time due to activities within the coverage area.

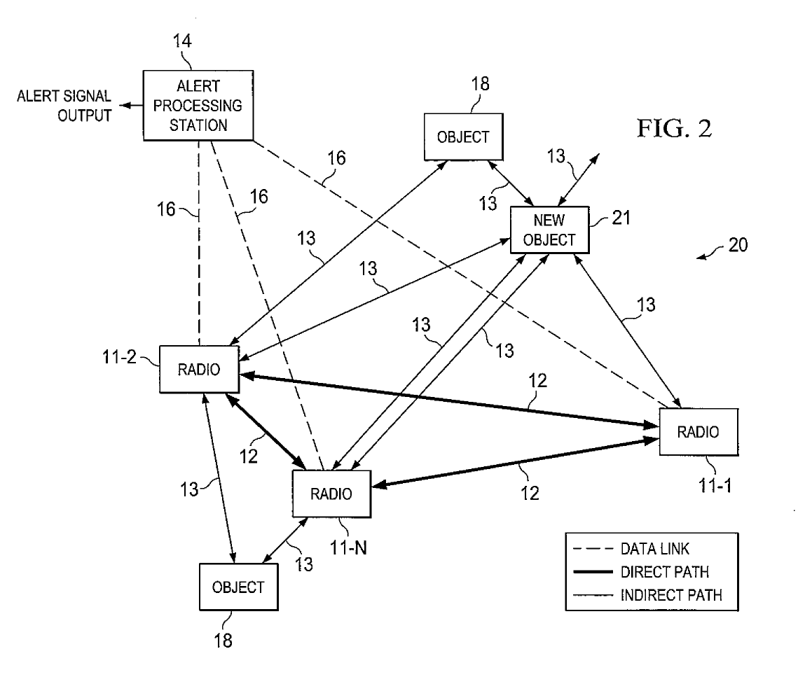

FIG. 2 illustrates one embodiment 20 of a changed signature occasioned by the addition of an object, such as object 21, into the transmission space. In this example, adaptation of the EMP environment algorithm involves creating a spatial signature of the EMP environment. The radio operation is based on the last known spatial signature until the EMP environment changes, such as occurs when object 21 enters the picture. When the signature changes a process begins to determine what caused the change. As will be seen, the change in signature occasioned when object 21 is encountered triggers a surveillance function. From that point forward until the next detected signature change the system processes communications without incident.

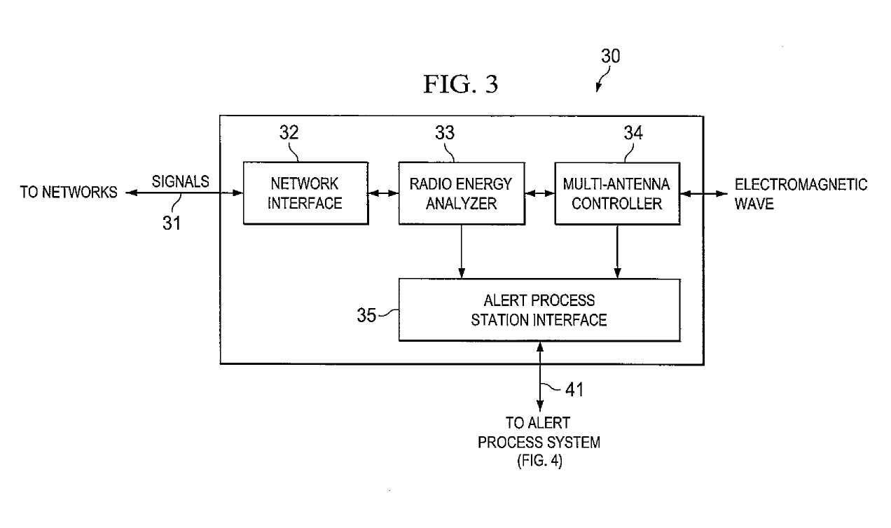

FIG. 3 illustrates one embodiment 30 of the radio control functions used in the present invention. In this embodiment, the functional diagram assumes that the radio has a function in addition to the surveillance function. Such a function can be any wireless communication function external to the surveillance function. Network interface 32 is used for this purpose and the interface, working in conjunction with radio frequency analyzer 33 performs like any typical radio function (e.g., modulation and demodulation, up and down frequency shifter, input and output are radio frequency signals). If the signal modulation is DS-CDMA or OFDM, then EMP adaptation is possible. For DS-CDMA modulation, the “Rake” filter in the demodulation would produce a spatial signature in the form of relative time delays and magnitudes of each multi-path signals. The relative time delay means the time delay relative to the first or earliest received signal. For OFDM modulation, the spatial signature is based on the signal nulling frequencies. (The frequency response of a multi-path signal would be null at some frequency due to multi-path signal cancellation.)

Multi-antenna controller 34 controls multi-path environments. This is perhaps the most powerful technique for the radio surveillance system. In this embodiment, the multi-path function uses MIMO technology. The MIMO technology can be used alone or with any radio types. If the radio modulation is DS-CDMA or OFDM together with the MIMO, the embodiment would use the MIMO spatial signature as the prime and DS-CDMA or OFDM would provide supplementary information. The spatial signature for MIMO would provide a set of magnitudes and phases for each antenna. For example, if three antennas are used, the spatial signature has three magnitudes and three phases.

Any changes in the spatial signature triggers the immediate sending of a copy of the new spatial signature from the detected radio to the alert processing station via a communication link, such as alert process station interface 35, which could be a part of the radio surveillance system or an independent communication system. The actual type of alert communication is immaterial to proper operation, except that high speed data alert transfer is preferred so as to reduce latency of intrusion processing. Note that latency can be further reduced by incorporating some or all the functions of the alert processing into the RF node(s).

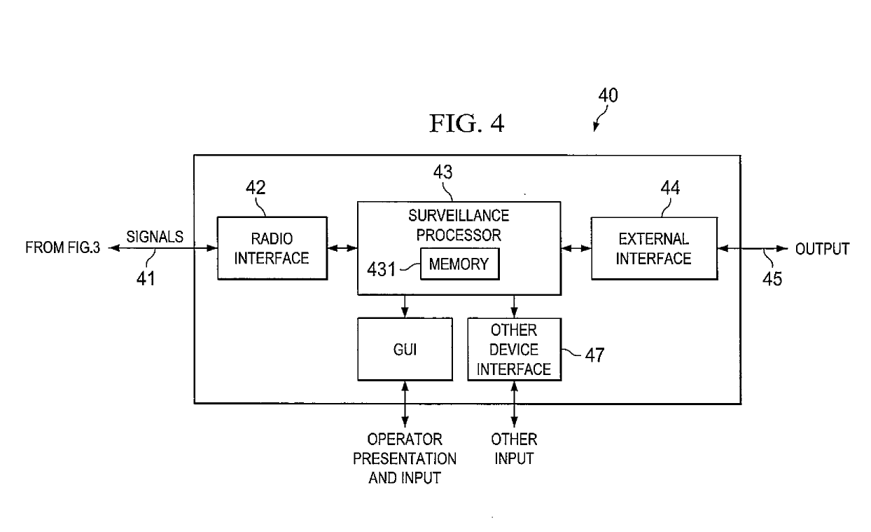

The function of the alert processing station is to determine what action needs to be taken when a spatial signature change occurs since each spatial signature change could mean different things under different conditions. For example, a spatial signature change in a busy office in the day time likely has little meaning and may be ignored. However, if a change occurs at night, or at a special location, etc., the change could be of interest for any number of reasons. If the system has a video surveillance system, the operator could use the change signal to automatically adjust the video screen and camera to the location where the change has occurred. One of the many possible applications of the alert processing station is to have a programmable GUI interface with optional selections based on operator/end-user requirements. Also, past history, as stored in a data base, such as data base 401, FIG. 4, can be used to characterize a particular new signature. Signatures arriving before and after a particular signature change can also be sued to characterize the change.

FIG. 4 illustrates one embodiment 40 of an alert processing system. As discussed, change in signature signal 41 is provided to radio interface 42. This input signal is determined primarily from the spatial signatures of the radios. The message contents of signal 41 will include the input signal as well as perhaps one or more of the following: the radio ID, updated spatial signature, time stamp, etc. When signal 41 arrives radio interface 42 sends all or part of the signal to surveillance processor 43 to determine what action, if any, should be taken. Processor 43 can operate in conjunction with one or more other devices, via GUI interface 46 and/or other device interface 47, to help determine the proper action. For example, it may be necessary to incorporate inputs from other sensors, or from other surveillance channels, or from human operators to help determine what the change in spatial signature means. When that action is determined, external interface 44 sends control signals to the necessary locations and/or devices to initiate the action desired.

Assuming the radios are installed and fully operational, processor 43 uses information all of the information available to it from the various sources. It is possible to construct, either by modeling or by actual recording, signatures and signature patterns, that are representative of certain occurrences. For example, a person moving across a space will result in a certain signature pattern that can be stored. Then, when that same signature pattern is later detected, the system can make a determination that the signature change(s) being detected is most likely a person or persons moving across the space.

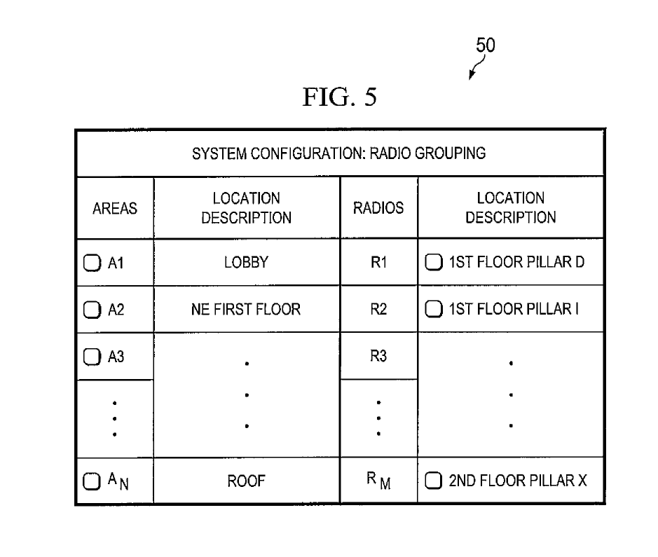

FIG. 5 illustrates one embodiment of a GUI for radio grouping. The purpose of the grouping is to allow an operator, or the processor, to identify the surveillance area or sub-area where the signature change has been detected. Areas can be established for a wide variety of purposes. For example, a super secure area should not be grouped with an area that does not require the same security functionality. In one mode of operation, the operator, enters into the system the location identity for A1, A2 . . . etc., as displayed from processor 43. This then allows the operator to identify the physical location from which the signature change has occurred. Alternately, the operator could select an area for surveillance and direct radios to be broadcast to each other through that area to see if signature changes are currently occurring in that area. The current signature change pattern can be compared to previous signature change patterns using a specific time of day, day of week, day of year, etc., method or using a statistical model or any other model to determine if a problem exists.

In this embodiment the operator could also enter location and identity information for each radio (e.g., for correlation, maintenance, replacement, etc.). Once the location and identity details have been entered, grouping can be used to define which radio is in which real group, virtual group, or sub-group thereof, for example. In this embodiment the next step allows the operator to define the alert security classification. While this aspect does not impact the radios, it may be important for the radio surveillance system to know what alert action should be executed when an alert has occurred.

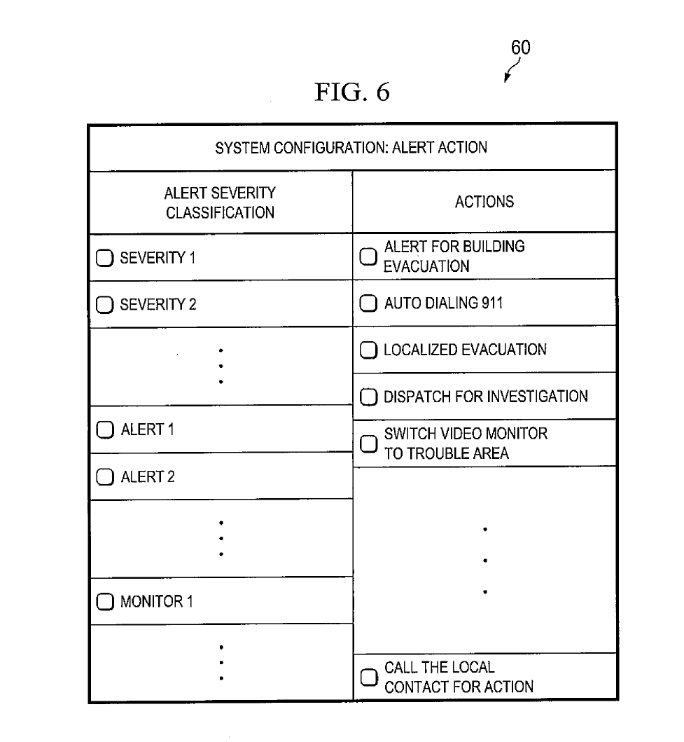

FIG. 6 shows one embodiment 60 for defining the alert action. For example, FIG. 6 shows that Severity 1 is the highest alert level meant for evacuating the building, automatically dialing 911 with predefined voice commands, sending other messages (e.g., voice, video, email, pager, etc.), and executing other commands (e.g., elevator shutdown). The operator should be able to define the actions for each class of alert levels. Once this is done, the alert processing station would have the capability of turning on any external system to produce the right alert signals.

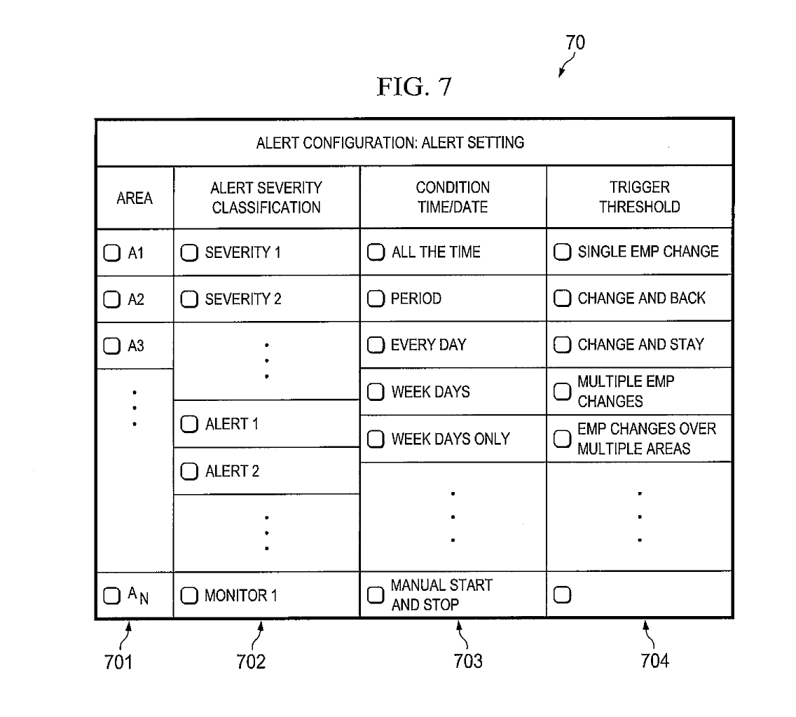

FIG. 7 illustrates one embodiment 70 of an operator interface for an alert setting in which the GUI can be used to establish what alert level should be reported when the radio surveillance detects a particular EMP change. Using the GUI, any alert can be initiated from a particular event. “Trigger Threshold” (shown in column 704) could include a list of all possible reports from the radio surveillance system. The report could be a signature change from a single radio set. In such a situation, any change in the signature would trigger an output action. Or the report could require multiple changes from a single radio set or from multiple radio sets. Or the report could be one signature change and no further change (change and stay). Or the report could require that the signature change only for a short time and then revert back to the same signature as before the change (change and change-back) etc.

Example 1, Assume A1 (column 701) is a restricted area. Assume also that the operator is monitoring video surveillance at all times. The optional settings for the operator are:

Option 1: Select A1, Severity 1 (column 702), all the time (column 703) and single EMP change (column 704). With this setting, the operator would receive an alert every time there is an EMP change. This alert option would allow the operator to only monitor the video screen(s) when the alert is activated. Additionally, each alert can be time stamped to simplify play back searches. This setting works well if EMP changes are infrequent.

Option 2: Select A1, in a defined period, and single EMP change and select A2, Alert 1, all the time and single EMP change. (A2 could be, for example, the entrance and exit area of A1.) With this setting, the frequency of alerts would be reduced, because it provides alerts only when an object is moving in and/or out of the entrance and exit area.

Example 2 is for an area with variable severity classification based on times and dates, such as may be found at a typical office, This setting is the same as example 1, but the differences are the classification changes with time and dates.

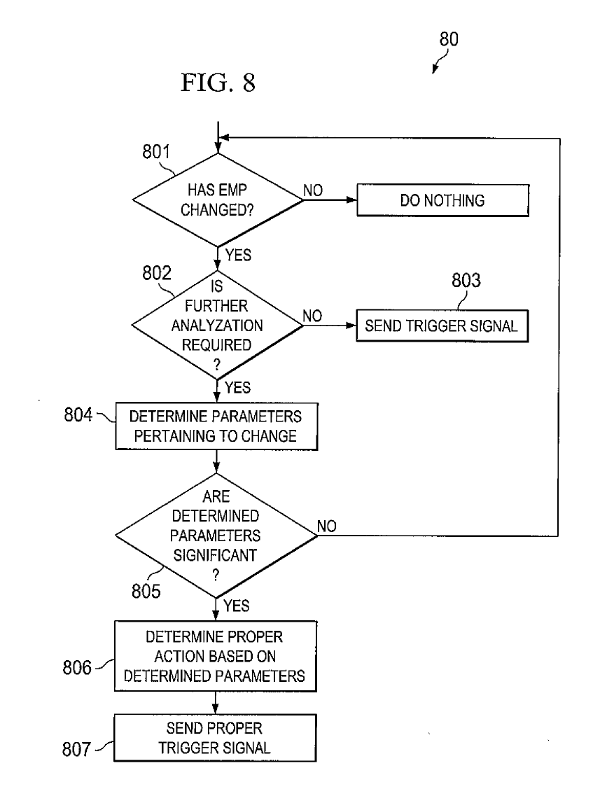

FIG. 8 shows one embodiment 80 of a flow chart of system operation. As shown, process 801 determines in any of a number of ways if the electromagnetic propagation between communicating radios has changed. This determination can be made, for example, if the spatial signature has changed as discussed above. If there is a change, process 802 determines if the conditions surrounding the detected change need to be further analyzed. For example, in some applications any change for any reason is enough to cause a signal to be sent outside the radio system to, for example, a surveillance system.

In other situations it may be desirable to go into more depth to determine factors surrounding the change or to examine the magnitude of the change. In such situations not all changes are treated equally. If process 802 determines that further analysis is not necessary, then process 803 sends a trigger signal to a device or location for use by that device or location to take some action based on the detected EMP change.

If, however, further processing is required, then process 804 performs this analysis according to guidelines established by a user. This further analysis could be as simple or as complex as desired and could be based on: expected changes, unexpected changes, time of occurrence, statistics compiled over a period of time with respect to other recorded changes, patterns put into the database by the user, etc. Process 805 then determines, based on the detailed analysis of the EMP change(s) if they are significant. In this context, significant means that some action is to be taken. If so, then process 806 determines what the proper course of action should be, based upon a set of pre-established guidelines as discussed above and process 807 then sends the proper signal(s) to trigger the response.

In some cases, the response is simply that an operator is alerted that something may be wrong. In other situations, the response could be a rearrangement of radio communications “looking” for specific additional information, either from the radio communications or from some other surveillance function.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A surveillance system comprising:
at least one pair of radios, said radios adapted for communicating with each other across a volume of space;
means for determining when a spatial signature of a particular communication has changed; and
means enabled by a determined change for providing an alert signal outside of said radio pair.

2. The system of claim 1 further comprising:
means for processing spatial signature changes to determine a type of signal to be provided.

3. The system of claim 2 further comprising:
a plurality of radio pairs; and
wherein said processing includes spatial signature information from more than one radio pair.

4. The system of claim 2 wherein said processing further comprises:
means for allowing an operator to input information in real time.

5. The system of claim 1 wherein said radios serve a wireless communication function in addition to said surveillance.

6. A system for detecting intrusion into an area, said system comprising:
an analyzer for determining when a radio transmission's electromagnetic propagation (EMP) changes; and
an alerting interface for providing a signal indicating a detected EMP change.

7. The system of claim 6 wherein said analyzer further determines specific parameters pertaining to said EMP change; and
wherein said signal is provided only when certain specific parameters are determined.

8. The system of claim 7 wherein said analyzer determines said specific parameters, at least in part, based on differenced of the multi-path signals from one EMP environment to another EMP environment.

9. The system of claim 8 wherein said analyzer further determining when said radio transmission's EMP changes once again; and wherein said alerting interface is further operative for providing another signal indicating said subsequently detected EMP change.

10. The system of claim 9 wherein said EMP change is based upon disturbance in electromagnetic propagation from a transmitter to a receiver.

11. The system of claim 6 wherein said analyzer is part of an adaptive radio communicating with another radio.

12. A radio surveillance system comprising:
at least two EMP adaptive radios in communication with each other, said radios operative for reporting spatial signature changes between them; and
an interface for triggering events outside of said radios due to a reported change in a spatial signature.

13. The system of claim 12 further comprising:
a processor for determining parameters concerning a reported signature change, and wherein said interface is operative to trigger events based upon said determined parameters.

14. The system of claim 13 wherein said radios are part of a wireless communication system.

15. The system of claim 14 further comprising:
an object placed in an area through which RF energy from said radios will pass, said object selectively changing electromagnetic propagation between said radios on a relatively permanent basis.

16. A radio comprising:
circuitry for reporting electromagnetic propagation (EMP) changes between said radio and at least one other radio in communication therewith, said reporting adapted to allow a system separate from said radio communication to determine when a particular area undergoes certain environmental changes.

17. The radio of claim 16 wherein said EMP changes are determined by a change in spatial signature.

18. A method for performing surveillance, said method comprising:
determining when electromagnetic propagation (EMP) changes between radios that transmit RF energy through a particular space being monitored; and
providing an alert signal based upon a determined EMP change.

19. The method of claim 18 further comprising:
tailoring said alert signal dependant upon particular characteristics of said determined EMP change.

20. The method of claim 19 wherein said determining is based upon at least one of the following: statistics of other EMP changes; time of said EMP change; a plurality of EMP changes in a particular time period.

21. The method of claim 20 further comprising:
rearranging objects in a area through which RF energy from said radios pass to adjust RF propagation paths.
